(19) United States
(12) Patent Application Publication
(10) Pub. No.: US 2007/0057795 A1
(43) Pub. Date: Mar. 15, 2007

(54) Inspection method of RFID tag

(76) Inventors: Wakahiro Kawai, Kyoto-fu (JP); Kazuhiro Kudo, Kyoto-fu (JP)

Correspondence Address: DICKSTEIN SHAPIRO LLP, 1825 EYE STREET NW, Washington, DC, 20006-5403, US

(21) Appl. No.: 11/501,052

(22) Filed: Aug. 9, 2006

(30) Foreign Application Priority Data
Sep. 12, 2005 (JP) 2005-26372

(51) Int. Cl. G08B 13/14

(52) U.S. Cl. 340/572.7

(57) ABSTRACT

A method for inspecting a communication condition of an RFID tag that is readable in a noncontact manner using an electromagnetic wave is provided, in which when a communication condition of the RFID tag is inspected, it can be inspected without needing an electromagnetic-wave shield device for preventing diffusion of the electromagnetic wave. When an RFID tag having an antenna communicating using communication frequency of a UHF band, and a matching circuit adjusting impedance of the antenna, is inspected an antenna coil of a reader-writer is opposed to the matching circuit, and a control circuit of the RFID tag is operated by magnetic flux transmitted from the antenna coil, so that the RFID tag is inspected.

### BACKGROUND OF THE INVENTION

1. Field of the Invention

The present invention relates to an inspection method of an RFID (Radio Frequency Identification) tag used for communication from a distant position using an electromagnetic wave in an UHF band, and more specifically relates to an inspection method for accurately inspecting an RFID tag before shipment and apparatus for the inspection, a communication method of the RFID tag and apparatus for the communication, and the RFID tag.

2. Description of Related Art

Automation has been promoted in various fields such as a physical distribution field. When automation is promoted in the distribution field, it is essential that information recorded in a slip or the like attached to an individual article is machine-readable. As a method of realizing such automation, a barcode label has been attached to an individual slip, the label being corresponding to the recorded information in the slip.

However, to read the barcode label using a barcode reader, a distance between the barcode reader and the barcode label needs to be accurately connected with a direction of the barcode reader directed to the barcode label. Since the connection between the distance and the direction is manually established in each case, much time is taken, consequently read operation of the barcode has obstructed facilitation of the physical distribution. Furthermore, since only a small amount of information can be inputted into the barcode, a region that can be controlled by using the barcode label has been limited to a narrow region.

From such background, an RFID tag is currently noted, which can be read in a noncontact manner by using an induction field or electromagnetic wave. According to the RFID tag, since the induction field or electromagnetic wave is used as a reading medium, distance and direction limitations are not significantly given in reading. For example, the RFID tag using the electromagnetic wave is not restricted in reading directivity, and information recorded therein can be surely read even from a distance of 1 to 5 m.

Here, a basic configuration of the RFID tag includes two components of an IC chip having a radio-frequency interface section, control logic section, and storage section within the chip, and an antenna circuit board for transmitting and receiving the electromagnetic wave. As a typical communication medium of the RFID tag, an electromagnetic wave in an UHF band of 850 to 960 MHz may be used for communication frequency.

Generally, when the RFID tag is inspected, an RFID tag is configured by connecting an electronic component such as IC to an antenna circuit, and then inspection is performed through communication in a noncontact manner using the electromagnetic wave.

On the other hand, in an RFID tag (see FIG. 1) 80 using the communication frequency of the UHF band exemplified in FIG. 8, when an antenna 81 of a reader-writer is disposed below and opposite RFID tags 80 arranged in three lines, communication can not be performed unless an RFID tag 80 as an inspection object is wholly placed within an electromagnetic region 82 formed by the antenna 81. Therefore, when the RFID tags 80 are successively inspected in a configuration as shown in FIG. 8, a difficulty arises, that is, a different RFID tag 80 juxtaposed to the RFID tag 80 as the inspection object may be placed in the electromagnetic region 82, causing interference, consequently the RFID tag 80 as the inspection object can not be accurately inspected.

To solve such a difficulty, as an example of a method for accurately inspecting the RFID tag in the UHF band, as disclosed in JP-A-2004-272437, a method is proposed, in which a shield box (electromagnetic wave shield device) for preventing diffusion of the electromagnetic wave is provided, thereby a communication area is formed in a space where the electromagnetic wave is shielded, and only the RFID tag as the inspection object is supplied into the space for inspection.

However, in such an inspection method of the RFID tag in the related art, there is a difficulty that a detection device is increased in size because of the shield box, in addition, there has been a difficulty that since the shield box needs to be adapted for external size of the RFID tag as the inspection object, when a form or size of the RFID tag is varied, communication and inspection can not be carried out in the same device.

### SUMMARY OF THE INVENTION

According to the invention, in view of the difficulties described above, it is desirable to provide a method for inspecting a communication condition of the RFID tag communicated using the electromagnetic wave; wherein even if the electromagnetic wave shield device is omitted, inspection or communication can be accurately performed only to the RFID tag as the inspection object, and apparatus for the inspection or communication, and an RFID tag.

An embodiment of the invention includes an inspection method of an RFID tag for inspecting an RFID tag having an antenna communicating using the communication frequency of the UHF band, and a matching circuit adjusting impedance of the antenna; wherein an antenna coil of a reader-writer is opposed to the matching circuit, and a control circuit of the RFID tag is operated by magnetic flux transmitted from the antenna coil, so that the RFID tag is inspected.

In an aspect of the embodiment of the invention, size of the antenna coil of the reader-writer can be made approximately the same as size of the matching circuit of the RFID tag for inspection of the RFID tag.

In another aspect of the embodiment of the invention, matching circuits of a plurality of RFID tags arranged at a constant interval can be opposed to antenna coils of a plurality of reader-writers arranged at approximately the same arrangement interval as that of the matching circuits respectively for inspection of the plurality of RFID tags at the same time.

Moreover, the embodiment of the invention includes inspection apparatus of an RFID tag for inspecting an RFID tag having an antenna communicating using the communication frequency of the UHF band, and a matching circuit adjusting impedance of the antenna; wherein an antenna coil can be provided for inspection of the RFID tag, the coil being opposed to the matching circuit and transmitting magnetic flux.

In an aspect of the embodiment of the invention, the antenna coil of the reader-writer can be formed to have approximately the same size as size of the matching circuit of the RFID tag for inspection of the RFID tag.

In another aspect of the embodiment of the invention, the RFID tag can be inspected in a configuration that a plurality of the antenna coils are provided in line, and a plurality of RFID tags opposed to the antenna coils one by one are inspected at the same time.

Moreover, an embodiment of the invention includes a communication method of an RFID tag for communication with an RFID tag having an antenna communicating using the communication frequency of the UHF band, and a matching circuit adjusting impedance of the antenna; wherein an antenna coil of a reader-writer is opposed to the matching circuit, and communication with a control circuit of the RFID tag is performed by magnetic flux transmitted from the antenna coil.

In an aspect of the embodiment of the invention, the antenna coil of the reader-writer can be provided to have approximately the same size as size of the matching circuit of the RFID tag for communication with the RFID tag.

In another aspect of the embodiment of the invention, matching circuits of the plurality of RFID tags arranged at a constant interval are opposed to antenna coils of a plurality of reader-writers arranged at approximately the same arrangement interval as that of the matching circuits, so that communication can be performed at the same time between the plurality of RFID tags and reader-writers.

Moreover, the embodiment of the invention includes communication apparatus of an RFID tag for communication with an RFID tag having an antenna communicating using the communication frequency of the UHF band, and a matching circuit adjusting impedance of the antenna; wherein an antenna coil that transmits magnetic flux can be provided oppositely to the matching circuit for communication with the RFID tag.

In an aspect of the embodiment of the invention, the antenna coil of the reader-writer can be formed to have approximately the same size as size of the matching circuit of the RFID tag for communication with the RFID tag.

In another aspect of the embodiment of the invention, a configuration is made for communication with the RFID tag, in which a plurality of the antenna coils are provided in line, and communicate with a plurality of RFID tags at the same time, the tags being opposed to the antenna coils one by one.

Furthermore, in another aspect of the embodiment of the invention, an RFID tag used in the communication method of the RFID tag can be configured to have a separation position specifying unit in a part of the antenna circuit board, which does not break the matching circuit, but breaks an antenna structure, which communicates using the UHF band, while specifying a separation position.

According to the embodiment of the invention, the RFID tag can be inspected stably in a simple configuration irrespectively of a shape or size of the RFID tag.

### BRIEF DESCRIPTION OF THE DRAWINGS

FIGS. 1A to 1B are explanatory views of an RFID tag using communication frequency of a UHF band;

FIG. 2 is a perspective view showing an inspection condition of the RFID tag;

FIG. 3 is a schematic block diagram of a matching circuit and an antenna coil of a reader-writer;

FIG. 4 is a perspective view showing a use condition of RFID tag inspection apparatus for an RFID tag roll;

FIG. 5 is an explanatory view showing inspection conditions from a surface side and a back side of the RFID tag;

FIG. 6 is a perspective view showing an inspection condition of an RFID tag having anther antenna configuration;

FIGS. 7A to 7B are explanatory views showing a separation condition of an RFID tag having a separation seal; and

FIG. 8 is a perspective view showing a communication condition where a plurality of RFID tags are opposed to antennas of reader-writers in the UHF band.

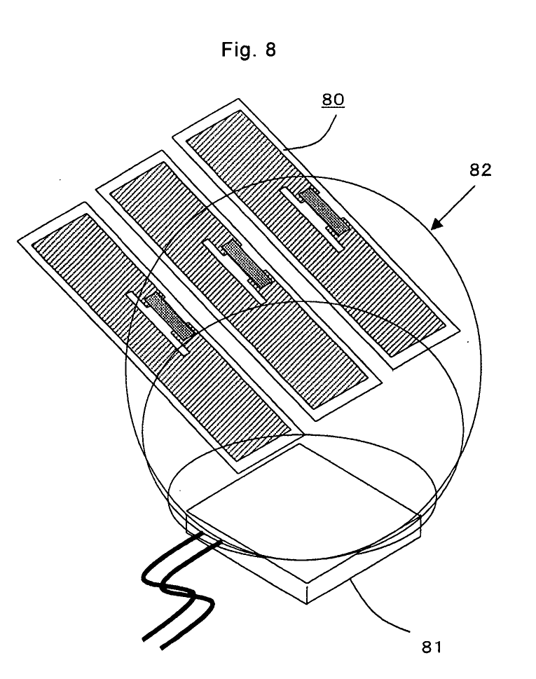

### DESCRIPTION OF THE PREFERRED EMBODIMENT

An embodiment of the invention will be described according to drawings.

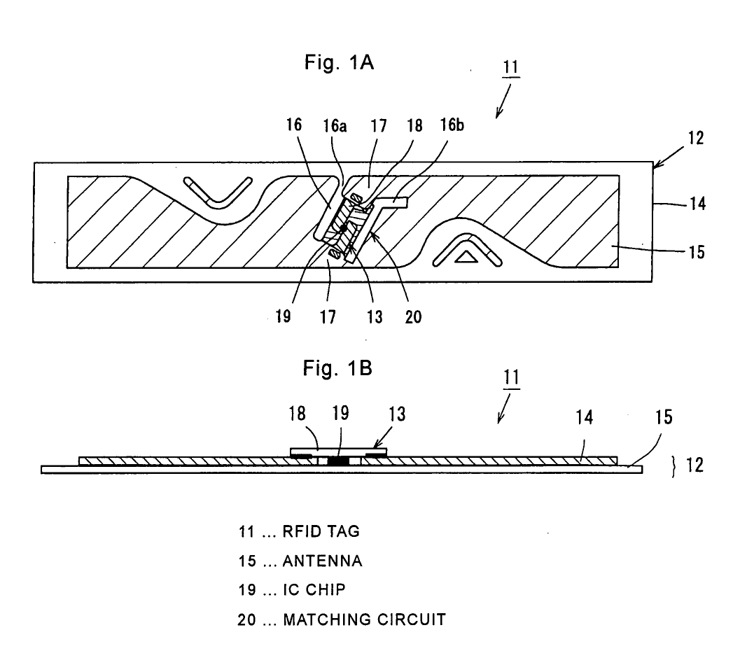

FIGS. 1A to 1B show an RFID (Radio Frequency Identification) tag 11 using the frequency of the UHF band of 850 to 960 MHz, and FIG. 1A shows a plane view of the RFID tag 11, and FIG. 1B shows a front view of the RFID tag 11. The RFID tag 11 is configured by an antenna circuit board 12 having a rectangular sheet shape, and an IC module 13 formed in a sufficiently small rectangular shape compared with the antenna circuit board 12.

In the antenna circuit board 12, a cupper antenna 15 is provided on a top of a film 14 that is made of PET (polyethylene terephthalate) and has a rectangular shape, the antenna 15 being slightly smaller than the film 14. Both of the film 14 and the antenna 15 are sheet members having constant thickness and softness allowing appropriate bendability.

The antenna 15 is a printed circuit having a cutout portion 16 in an approximately quadrilateral shape in the center. Upper and lower sides in the figure of the cutout portion 16 are connecting portions 17, 17 for the IC module 13, and a slit 16a is provided in the left of the upper connecting portion 17 in the figure. On a top of the antenna 15, an insulating layer omitted to be shown is provided.

In the IC module 13, an IC chip (semiconductor bare chip) 19 is mounted between the shown, upper and lower connecting portions 17, 17 of the antenna 15 via a small sheet slap 18. The IC chip 19 is a typical IC chip having a storage section, resonance section, rectifier circuit, voltage detection circuit, control circuit, and constant-voltage circuit within the chip.

Here, in the cutout portion 16 of the antenna 15, a closed hole 16b forming a reverse L-shape in the right of the slap 18 is formed as a matching circuit 20 for adjusting impedance of the antenna 15 as a whole which communicates using the communication frequency of the UHF band. An outer circumferential portion enclosing the closed hole 16b is the matching circuit 20. An antenna coil is arranged facing the matching circuit 20 for communication, the antenna coil being provided in approximately the same size as size of the circuit 20 at a side of a reader-writer described later.

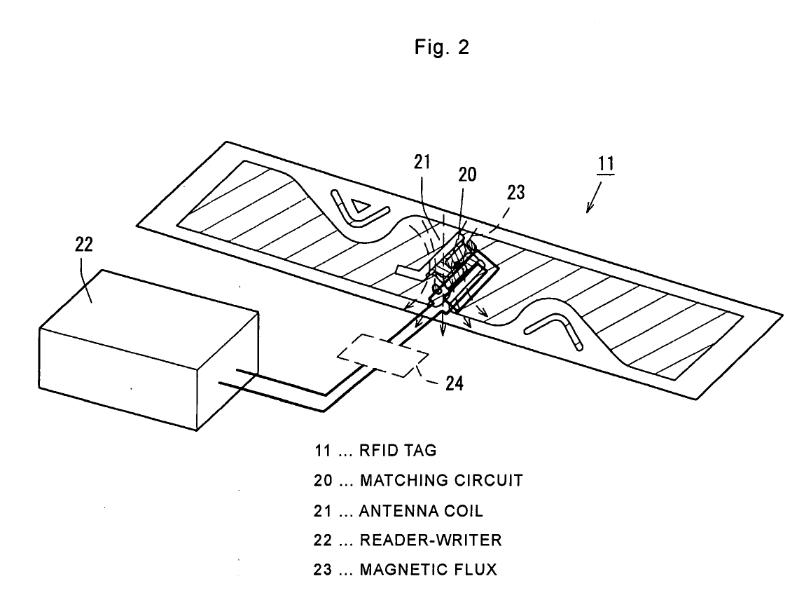

FIG. 2 shows an inspection method of the RFID tag 11 according to the invention. In the inspection method of the RFID tag 11, approximately directly above the matching circuit 20 formed in the antenna 15 of the RFID tag 11, an antenna coil 21 having one to several turns (two turns in the figure) is arranged facing the matching circuit, the antenna coil being formed in approximately the same size as size of the matching circuit 20. In the inspection method, the antenna 15 and the matching circuit 20 are set with facing interval between them of about several millimeters at that time, and power having inspection frequency of 850 to 960 MHz and output of 10 to 30 dBm is supplied from a reader-writer 22 to the antenna coil 21 to generate magnetic flux 23 from the antenna coil 21, and the matching circuit 20 of the RFID tag 11 is placed in such a magnetic field environment for inspection.

When the power from the reader-writer 22 is supplied to the antenna coil 21, the magnetic flux 23 is transmitted from the antenna coil 21, rather than the electromagnetic wave, and the transmitted magnetic flux 23 passes through the inside of the matching circuit 20, thereby induced electromotive force is supplied to the RFID tag 11, so that the RFID tag 11 is operated.

In the inspection method, the small matching circuit 20 formed in the antenna 15 of the RFID tag 11 is placed in the small magnetic field (magnetic flux 23) generated by the antenna coil 21 of the reader-writer 22, and only by that, the RFID tag 11 can be inspected. Therefore, even if the antenna 15 of the RFID tag 11 in a flat sheet shape provided for the UHF band is not fully placed in the environment of the electromagnetic wave in the UHF band, communication with the RFID tag 11 can be performed, and consequently inspection can be performed under small magnetic-field environment.

As a result, since small magnetic field is used for inspection of the RFID tag 11 for the UHF band, and a wideband electromagnetic wave is not used, the antenna transmitting the electromagnetic wave need not be covered with the electromagnetic-wave shield device such as electromagnetic-wave shield box. Therefore, even if a different RFID tag is present at the periphery of the RFID tag as the inspection object (measurement object), communication can be performed only with one RFID tag as the inspection object, and there is no possibility of interference with the different RFID tag.

The reason why the size of the matching circuit 20 of the RFID tag 11 is provided to be approximately the same size as the size of the antenna coil 21 of the reader-writer 22 is because large difference in size between the two causes difficulty in matching when they are opposed for communication under the small magnetic-filed environment.

The antenna coil 21 transmitting the magnetic flux 23 is prepared in accordance with the size of the small matching circuit 20, therefore even if the external size or the shape of the antenna 15 of the RFID tag 11 is slightly changed, since a portion of the matching circuit 20 to be locally opposed is in the same structure, inspection can be performed using the same inspection apparatus of the RFID tag 11 without changing the inspection apparatus.

Since the matching circuit 20 is provided by forming the approximately quadrilateral cutout, the antenna coil 21 is provided in a quadrilateral shape in accordance with the cutout shape. In this case, the antenna coil 21 is formed to have one to several turns that is the number of turns by which the magnetic flux 23 can be stably generated. Furthermore, regarding the facing interval between the matching circuit 20 and the antenna coil 21 oppositely arranged on a top of the circuit, even if they are provided in a contact manner, the magnetic flux 23 can be similarly transmitted for communication.

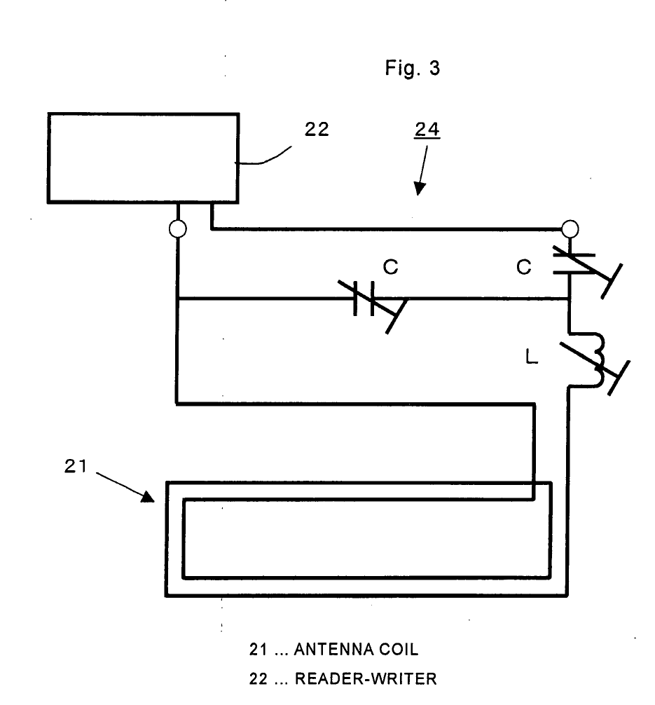

The reader-writer 22 is connected to the antenna coil 21 via a matching circuit 24. As shown in a circuit diagram of FIG. 3, the matching circuit 24 includes a variable capacitor C and a variable reactance L. The power supplied to the antenna coil 21 is controlled small by connecting the antenna coil with the matching circuit 24.

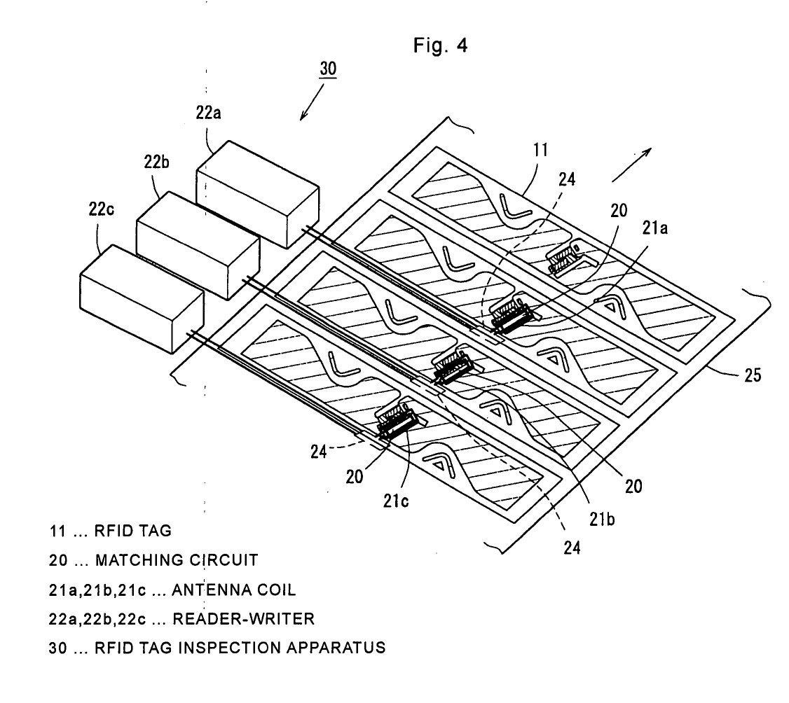

FIG. 4 shows an example of RFID tag inspection apparatus 30, which is designed such that, with respect to an RFID tag roll having a plurality of RFID tags 11 disposed in lines at a constant interval on a top of a roll-like carrier sheet 25 as a substrate of the RFID tags 11, the RFID tags 11 can be collectively inspected by a plurality of reader-writers 22a, 22b and 22c at the same time every certain number of tags, thereby inspection efficiency of the RFID tags 11 is improved.

The RFID tag inspection apparatus 30 is set, for example, in the end of a manufacturing line for manufacturing the RFID tag, and for each of the RFID tags 11 that have been manufactured and then guided into the apparatus, a communication condition of the manufactured RFID tag 11 is inspected using the RFID tag inspection apparatus 30.

Here, the RFID tag inspection apparatus 30 is configured by a plurality of reader-writers 22a, 22b and 22c, a drive section (omitted to be shown) paying out the RFID tag roll from an end and taking up the roll on a separated core, and a control section (omitted to be shown) controlling them. On a roll path extended between winding portions of the RFID tag roll, antenna coils 21a, 21b and 21c of the reader-writers 22a, 22b and 22c for transmitting the magnetic flux are set close to one another in upper positions facing the RFID tags 11 mounted in lines on the top of the RFID tag roll, and arranged oppositely to the RFID tags 11. Thus, the RFID tag 11 that has been carried is communicated with any one of antenna coils 21a, 21b and 21c for inspection under magnetic-field environment of the antenna coil, the coil having been opposed to the tag during carrying.

It is desirable to provide an output section outputting information on presence of abnormality when abnormality is found in inspection. The output section may be configured by a sound output section that gives an alarm, or a print output section that marks an abnormal RFID tag 11 by printing or the like.

In a collective inspection method in accordance with the RFID tag roll, since the magnetic-field environment under which communication is performed in a narrow communication region is used rather than the electromagnetic environment under which communication is performed in a wide communication region as described before, a plurality of RFID tags 11 can be collectively inspected. For example, when the antenna coils 21a, 21b and 21c of the three reader-writers 22a, 22b and 22c in line are arranged oppositely to corresponding matching circuits 20 of the plurality of RFID tags 11 arranged at a constant interval on the top of the carrier sheet 25 respectively, three RFID tags 11 can be inspected at the same time.

Here, since the respective antenna coils 21a, 21b and 21c are arranged at the same interval as the arrangement interval of the RFID tags 11 on the carrier sheet 25, three RFID tags 11 can be inspected in one inspection. Therefore, control can be made by the not shown control section provided in the RFID tag inspection detector 30 such that an inspection process is advanced three steps at a stroke to inspect next three tags, and consequently the RFID tags can be inspected at higher speed.

In particular, even in the case a specification of the RFID tag roll in which the RFID tags 11 are in a line at a constant interval, the electromagnetic shield device such as electromagnetic-wave shield box for separating the RFID tag as the inspection object from a different RFID tag is not necessary, consequently inspection apparatus of the RFID tag can be reduced in size. Moreover, the inspection apparatus can be simplified along with reduction in number of parts, consequently cost reduction can be achieved.

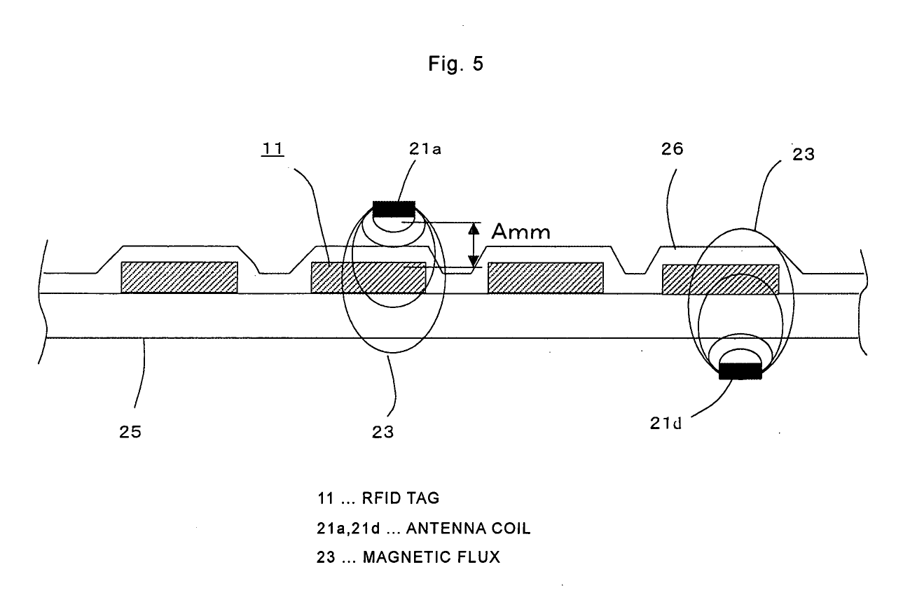

FIG. 5 is a side view showing an example of a condition of a successive inspection of the RFID tags 11 communicating under the magnetic-field environment. As a facing interval between the RFID tag 11 as the inspection object and the antenna coil 21 transmitting the magnetic flux, a slight distance of about A mm (for example, 2 mm) is given, so that the tag 11 and the coil 21 are disposed in a condition that electrical connection is unnecessary. Therefore, even if an insulating layer 26 including paper or PET is stacked on a surface of an RFID tag 11, the RFID tag 11 can be inspected. Moreover, while the antenna coil 21a is oppositely arranged at an upper side of the RFID tag 11 in FIG. 5, even if an antenna coil 21d, which transmits the magnetic flux 23 from a lower side, or a side of the carrier sheet 25 as the substrate of the RFID tag 11, is oppositely arranged, the RFID tag 11 can be inspected. In each case, since an effective range of the magnetic flux 23 does not reach an RFID tag 11 next to the RFID tag 11 as the inspection object, the RFID tags 11 can be surely inspected one by one.

In the circuits that receive the magnetic flux 23 from the respective antenna coils 21, 21a, 21b, 21c and 21d, while the slit 16a was shown as the impedance matching circuit 20, in addition, if there is a circuit in a wound configuration having a nonconductive portion that transmits the magnetic flux 23, any portion in the antenna circuit of the RFID tag 11 may be used. However, both ends of the circuit in the wound configuration need to be connected to two terminals of the IC chip.

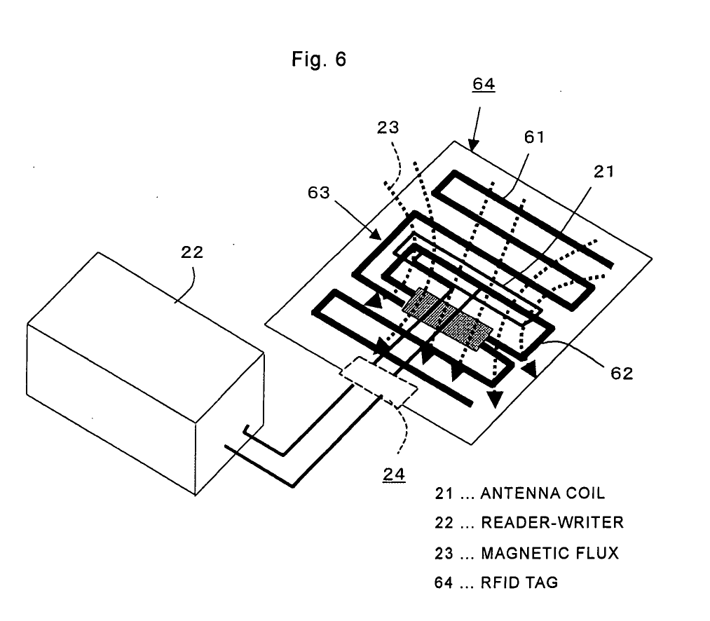

For example, as shown in FIG. 6, when a circuit 63 in the wound configuration in combination of a dipole antenna 61 and a loop antenna 62 is configured, and on the circuit 63 in the wound configuration, the antenna coil 21 extended from the reader-writer 22 via the matching circuit 24 is oppositely arranged, and the magnetic flux 23 is transmitted from the antenna coil 21 to the circuit 63 in the wound configuration, operation of an RFID tag 64 can be inspected as well.

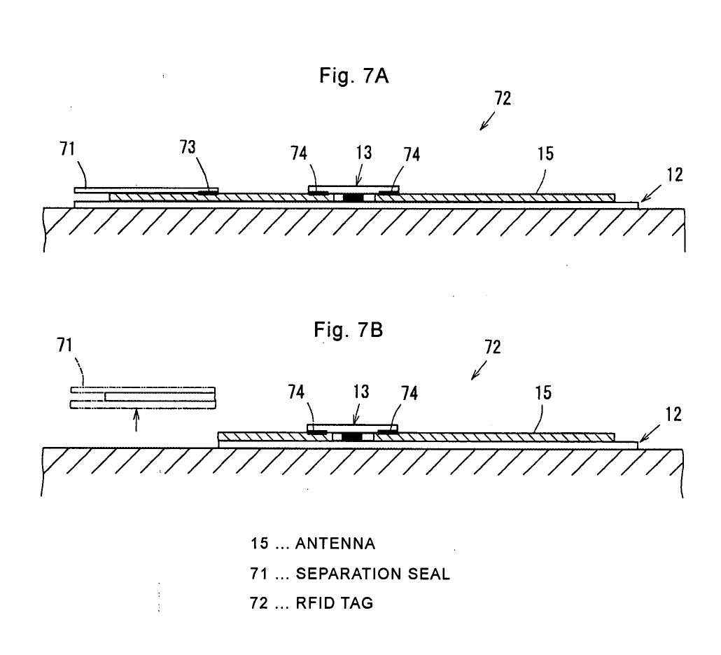

FIG. 7 shows an RFID tag 72 having a separation seal 71 for breaking the antenna, and the RFID tag 72 has the antenna circuit board 12 having the rectangular sheet shape, and the IC module 13 formed in the sufficiently small rectangular shape compared with the antenna circuit board 12 as the described RFID tag 11, in addition, as shown in FIG. 7A, it has the separation seal 71 attached to a top of one side of the antenna 15 of the antenna circuit board 12. The separation seal 71 is provided in the outside with respect to an adhering portion 73 formed on the RFID tag 72 in a view seen from the IC module 13.

By providing the separation seal 71, at a point when the separation seal 71 separated, as shown by an imaginary line in FIG. 7B, the antenna circuit board 12 united with the separation seal 71 is removed in such a manner that one side (outside of the adhering portion 73) is cut out, so that a structure of the antenna 15 of the RFID tag 72 can be broken.

Therefore, after the antenna circuit board 12 has been partially cut out, the RFID tag 72 does not exhibit a communication function using the electromagnetic wave in the UHF band, and for example, regarding a used RFID tag 72, an antenna structure can be easily broken and the tag can be scraped. Moreover, since an RFID tag 72, part of which has been separated using the separation seal 71, is in an imperfect state where the antenna 15 was partially cut out, the tag can be known as used one at a glance. Moreover, even in the used RFID tag 72, if the described antenna coil 21 of the reader-writer 22 is arranged oppositely to the matching circuit of the RFID tag 72, communication of the information recorded in the RFID tag 72 may be allowed under the magnetic-field environment, and thus the information can be read.

In this case, the adhering portion 73 between the separation seal 71 and the antenna 15 and an adhering portion 74 between the antenna circuit board 12 and the IC module 13 have been bonded by ultrasonic welding and the like during manufacturing the RFID tag 72, and particularly for the separation seal 71, a side near the IC module 13 is set to be the adhering portion 73 for specifying a separation position. The adhering portion 73 for specifying the separation position becomes a start point of a crack when separating force is applied, consequently the separation position of the separation seal 71 can be specified to a particular point. The separation position is specified in this way, thereby highly reliable breaking operation can be performed for the RFID tag 72.

In this way, when the antenna circuit board 12 is separated using the separation seal 71, the adhering portion 73 of the separation seal 71 is separated, and the adhering portion 74 of the IC module 13 is not separated from the antenna circuit board 12. Furthermore, to facilitate the separation, a cut for separation may be previously made in a portion to be separated in the antenna circuit board 12.

In the inspection of the RFID tags 11, 72, for example, communication conditions of the RFID tags 11, 72 are inspected during an inspection before shipment after manufacturing the RFID tags 11, 72.

In addition, RFID tag communication apparatus may be formed. The RFID tag communication apparatus is preferably configured by the reader-writer 22, a communication result output section, and a control section controlling them. Regarding run of communication, an input section such as a push-down switch is provided, and the communication is started by push-down operation of the switch. Alternatively, when the RFID tag 11 periodically transmits a signal, the apparatus can receive the signal.

The communication result output section may be a display monitor of liquid crystal and the like, printer, or communication device that transmits and receives data, and a communication result may be reading data read from the RFID tag, or data showing whether write has succeeded or not after information has been written into the RFID tag 11. For example, the writing may be writing before shipment of the RFID tag 11. For identification of the inspection, for example, writing inspection for inspecting written information is preferably performed.

In communication with the RFID tags 11, 72, when matching circuits 20 of the RFID tags 11, 72 are placed in the magnetic-field environment of the antenna coil 21, the RFID tags can be used for communication for reading or writing information to be transmitted with respect to the RFID tags 11, 72, consequently even if the RFID tags 11, 72 are used for the communication, the same effects and advantages are obtained.

As described above, the small matching circuit formed in the antenna of the RFID tag is placed in the magnetic-field environment, thereby the RFID tag can be inspected. Therefore, since the electromagnetic wave is not used in inspection of the RFID tag, diffusion of the electromagnetic wave does not occur, and furthermore interference with an adjacent different RFID tag due to the electromagnetic wave does not occur. Consequently, the inspection apparatus of the RFID tag can be reduced in size by omitting the electromagnetic-wave shield device. Moreover, since the antenna coil is small, a plurality of antenna coils can be opposed to a plurality of RFID tags at the same time. Thus, the inspection can be collectively performed, consequently inspection efficiency can be improved.

In correspondence relationship between a configuration of the embodiment of the invention and the example, the separation position specifying unit of the embodiment of the invention corresponds to the separation seal 71 of the example, however, the embodiment of the invention is not limited to a configuration of the example, and can be variously used according to technical thought according to claims.

What is claimed is:

1. An inspection method of an RFID tag for inspecting an RFID tag having an antenna communicating using communication frequency of a UHF band, and a matching circuit adjusting impedance of the antenna:
wherein an antenna coil of a reader-writer is opposed to the matching circuit, and a control circuit of the RFID tag is operated by magnetic flux transmitted from the antenna coil, so that the RFID tag is inspected.

2. The inspection method of the RFID tag according to claim 1:
wherein size of the antenna coil of the reader-writer is made approximately the same as size of the matching circuit of the RFID tag.

3. The inspection method of the RFID tag according to claim 1 or 2:
wherein a plurality of RFID tags are inspected at the same time in a manner that matching circuits of the plurality of RFID tags arranged with a certain interval are opposed to antenna coils of a plurality of reader-writers arranged with approximately the same arrangement interval as that of the matching circuits respectively.

4. Inspection apparatus of an RFID tag for inspecting an RFID tag having an antenna communicating using communication frequency of a UHF band, and a matching circuit adjusting impedance of the antenna:
wherein an antenna coil is provided, the coil being opposed to the matching circuit and transmitting magnetic flux.

5. The Inspection apparatus of the RFID tag according to claim 4:
wherein the antenna coil of the reader-writer is formed to have approximately the same size as size of the matching circuit of the RFID tag.

6. The Inspection apparatus of the RFID tag according to claim 4 or 5:
wherein a plurality of the antenna coils are provided in line, and a plurality of RFID tags opposed to the antenna coils one by one are inspected at the same time.

7. A communication method of an RFID tag for communication with an RFID tag having an antenna communicating using communication frequency of a UHF band, and a matching circuit adjusting impedance of the antenna:
wherein an antenna coil of a reader-writer is opposed to the matching circuit, and communication with a control circuit of the RFID tag is performed by magnetic flux transmitted from the antenna coil.

8. The communication method of the RFID tag according to claim 7:
wherein the antenna coil of the reader-writer is formed to have approximately the same size as size of the matching circuit of the RFID tag.

9. The communication method of the RFID tag according to claim 7 or 8:
wherein matching circuits of the plurality of RFID tags arranged at a constant interval are opposed to antenna coils of a plurality of reader-writers arranged at approximately the same arrangement interval as that of the matching circuits, so that communication is performed at the same time between the plurality of RFID tags and reader-writers.

10. Communication apparatus of an RFID tag for communication with an RFID tag having an antenna communicating using communication frequency of a UHF band, and a matching circuit adjusting impedance of the antenna:
wherein an antenna coil that transmits magnetic flux is provided oppositely to the matching circuit.

11. The communication apparatus of the RFID tag according to claim 10:
wherein the antenna coil of the reader-writer is formed to have approximately the same size as size of the matching circuit of the RFID tag.

12. The communication apparatus of the RFID tag according to claim 10 or 11:
wherein a configuration is made, in which a plurality of the antenna coils are provided in line, and communicate with a plurality of RFID tags at the same time, the tags being opposed
to the antenna coils one by one.

13. An RFID tag used in claims 7 to 9, comprising:
a separation position specifying unit in a part of the antenna circuit board, which does not break the matching circuit, but breaks an antenna structure, which communicates using a UHF band, while specifying a separation position.
